(19) United States
(12) Patent Application Publication
(10) Pub. No.: US 2018/0147532 A1
(43) Pub. Date: May 31, 2018

(54) Process For Concentration Of Lithium Containing Solutions

(71) Applicant: Albemarle Corporation, Baton Rouge, LA (US)

(72) Inventors: Jackson Reeves Switzer, Kings Mountain, NC (US); Neal J. Colonius, Baton Rouge, LA (US); Chi Hung Cheng, Baton Rouge, LA (US); Pieter Johannes Daudey, Zuid-Holland (NL)

(21) Appl. No.: 15/520,519

(22) PCT Filed: Oct. 16, 2015
(86) PCT No.: PCT/US2015/056090

§ 371 Date: Apr. 20, 2017

Related U.S. Application Data
(60) Provisional application No. 62/065,965, filed on Oct. 20, 2014.

(51) Int. Cl. B01D 61/58; C01D 15/04; B01D 61/02; B01D 69/12; B01D 61/00; C02F 1/44; C02F 103/02; C02F 103/10

(52) U.S. Cl. CPC B01D 61/58; C01D 15/04; B01D 61/025; B01D 69/125; B01D 61/002; C02F 1/445; C02F 2301/08; B01D 2311/103; B01D 2315/10; C02F 2103/02; C02F 2103/10; C02F 2209/001; C02F 2209/02; B01D 2311/25

(57) ABSTRACT

A forward osmosis process for concentration of lithium-containing salt solutions is described. A difference in osmotic pressure between a lithium-containing salt solution and a second salt solution of higher osmotic pressure is used as a driving force to pass water through a semi-permeable forward osmosis membrane from said lithium-containing salt solution of lower osmotic pressure to the salt solution of higher osmotic pressure. Also, a two-part operation is described wherein reverse osmosis process technology and forward osmosis process technology are used in tandem to concentrate lithium-containing salt solutions and to recover water that can be recycled to the process. The forward osmosis process is conducted without requiring (i) use of superatmospheric pressure or (ii) use of subatmospheric pressure or (iii) use of both such pressures, or (iv) use of one or more additives to assist in causing the flow of water through a forward osmosis membrane.

### TECHNICAL FIELD

This invention relates to new process technology for concentration of lithium-containing salt solutions. More particularly, this invention relates to a forward osmosis process for concentration of lithium-containing salt solutions, whereby a difference in osmotic pressure between a lithium-containing salt solution and a second salt solution of higher osmotic pressure is used as a driving force to pass water through a semi-permeable forward osmosis membrane from said lithium-containing salt solution of lower osmotic pressure to said salt solution of higher osmotic pressure. Also in this invention are processes in which the foregoing technology is utilized in a two-part operation, wherein reverse osmosis process technology and forward osmosis process technology are used in tandem to concentrate lithium-containing salt solutions while also for recovery of an amount of water than can be recycled to the process.

### BACKGROUND

One current method for concentrating dissolved salts at an industrial scale, to include lithium salts, from aqueous brine solutions is to expose brines to the action of sunlight in regions of limited rainfall whereby evaporation removes water from said salt solutions. Such processing requires the availability of land sites on which climate conditions enable evaporative processing to proceed at a timely rate on an economical basis. Another common method for concentrating brine on an industrial scale involves use of multistage evaporation in which brine is heated by steam to vaporize water.

There is need for a new way of concentrating lithium-containing salt solutions, especially those which contain lithium chloride or other lithium halide salts from natural sources such as aqueous brine solutions, without requiring reliance on evaporative processing. Various process approaches seeking to fulfill this need—e.g. solvent extraction, adsorption, and reverse osmosis—have been examined but are currently cost prohibitive or ineffective when used exclusively.

While development of forward osmosis related membranes, elements (configurations for a given membrane area), and units (also referred to as housings) for such forward osmosis membranes or elements, as well as some process applications of forward osmosis such as wastewater reclamation and desalination are known, no patent or scientific literature is known referencing successful development of a practical and economical process comprising forward osmosis process technology for concentration of lithium-containing salt solutions, especially those derived from subterranean brines. Instead, considerable efforts in recent years has been devoted to search for new, more effective membrane technology and to a lesser extent, research focusing on producing more effective materials for use as solutes in draw solutions. One early development along these lines is described in U.S. Pat. No. 3,130,156 which describes a procedure for extracting water from a saline solution for the purpose of producing potable water. In the patent's forward osmosis process, water is drawn from first saline solution through a semi-permeable membrane to a synthetic second solution containing ammonium bicarbonate (resulting from addition of ammonia and carbon dioxide). A hydrostatic pressure and temperature difference across the semi-permeable membrane is preferred to increase the rate at which water is extracted.

A few examples of more recent U.S. patent literature on the development of forward osmosis technology and some solute draw solution efforts include the following:
U.S. Pat. No. 7,445,712 describes formulations for, and modes of construction of, asymmetric forward osmosis membranes having high fluxes in forward osmosis applications. Said asymmetric forward osmosis membranes comprise a skin layer and a porous mesh support layer.
U.S. Pat. No. 8,354,026 describes center tube configurations for multiple spiral wound forward osmosis elements.
U.S. Pat. Appln. Nos. 2011/0203994 and 2012/0273417 describe a forward osmosis process involving extraction of water from a first aqueous solution through the use of a synthetic second solution, drawing water from said first solution across a semi-permeable membrane to said synthetic second solution utilizing an osmotic pressure gradient. The second solution used in the process is comprised of ammonia and carbon dioxide additives to promote the flow of solvent from the first solution across the semi-permeable membrane to the second solution.
U.S. Pat. Appln. No. 2012/0267307 describes multi-step osmotic separation systems and methods involving separations and recycles whereby additional solutes can be fed into a concentrated draw solution.

This invention provides a new practical, advantageous, and economical way of concentrating lithium salts especially lithium chloride from natural sources, typically aqueous brine solutions obtained from subterranean sources.

### Glossary

For convenience, the following terms are often, but not necessarily always, used hereinafter in the specification and claims in relation to the present invention whether or not preceded by identifiers such as “the”, “a”, “said”. etc. or other terms or are followed by more description of that particular solution:

The term “First Solution” refers to the lithium ion-containing solution of lower osmotic pressure that is used pursuant to this invention.

The term “Second Brine Solution” refers to the solution of higher osmotic pressure, which throughout the operation of the process is a more concentrated solution of soluble components such as salt(s) and becomes diluted in the process.

### NON-LIMITING SUMMARY OF THE INVENTION

This invention provides a forward osmosis process that has been developed and tested for the concentration of lithium-containing salt solutions. The process uses the difference in osmotic pressure between two solutions as a driving force to pass water through a semi-permeable membrane from the First Solution of lower osmotic pressure to a Second Brine Solution of higher osmotic pressure. In effect, the solution of lower osmotic pressure is concentrated, while the solution of higher osmotic pressure is diluted. In this invention, a dilute lithium-containing solution is used as the First Solution, while nearly saturated subterranean brine is used as the Second Brine Solution. This is believed to be the first known successful development of the application of forward osmosis for the concentration of lithium-containing salt solutions, especially as part of a process for extracting lithium values from brine. Compared to other methods of concentration (e.g. evaporation, reverse osmosis, and forward osmosis processes using added osmotic pressure increasing agents), the forward osmosis process of this invention (1) require significantly less capital for installation and operation, and (2) require substantially less energy for operation.

Accordingly, this invention provides, inter alia, a process for increasing the concentration of dissolved lithium salt(s) in a First Solution having a content of at least one dissolved lithium salt, which process comprises:

(a) maintaining said First Solution in direct contact with one side of a semi-permeable forward osmosis membrane and

(b) maintaining in direct contact with the other side of said membrane, a Second Brine Solution a minimum content of dissolved salt(s) in the range of from about 15 wt % below the saturation point up to the saturation point of the Second Brine Solution, and having an inherent osmotic pressure that is higher than the osmotic pressure of said First Solution during the process,

(c) whereby the concentration of dissolved lithium salt(s) in said First Solution is increased by the flux of water from said First Solution through said membrane and into said Second Brine Solution so that the overall concentration of lithium in said First Solution is increased,

(d) independently maintain the temperature(s) of said First Solution and said Second Brine Solution in the range of about 5° C. to about 95° C., preferably in the range of about 20° C. to about 90° C. and more preferably in the range of about 25° C. to about 80° C., and still more preferably in the range of about 25° C. to about 75° C.,

(e) said process being further characterized in that it is conducted without requiring use of (i) superatmospheric pressure or (ii) subatmospheric pressure or (iii) both of superatmospheric pressure and/or subatmospheric pressure sequentially or consecutively or (iv) one or more additives to assist in causing the flow of water through said membrane from said First Solution and into said Second Brine Solution.

Among the preferred features of this invention is the exclusive use of the difference in the osmotic pressure of the First Solution and Second Brine Solutions as the driving force by which the lithium concentration is increased in the First Solution. The preferred second solution requires no additives and can be in some cases naturally occurring, originating from below the Earth's surface. Another important feature of this invention is the concentration and makeup of the second solution which provides for the driving force used in the process. Still another feature which constitutes a preferred embodiment of this invention, is the ability of the process to be operated over the range at which the solutions remain in the liquid state, and preferably in the range of about 20° C. to about 90° C. Other embodiments of this invention will appear hereinafter.

Other embodiments of this invention are processes in which the foregoing technology is utilized in a two-part operation, wherein reverse osmosis process technology and forward osmosis process technology are used in tandem to concentrate lithium-containing salt solutions while also providing an appreciable amount of water recovery. More particularly, this embodiment is a process for concentrating an aqueous First Solution containing in the range of about 1.500 to 4.500 ppm of dissolved lithium (Li+), which process comprises:

(a) subjecting said solution to pressurized reverse osmosis through a plurality of successive or parallel semi-permeable reverse osmosis membranes in units—with the applied pressure to said solution in said units not exceeding the present or any future maximum operating pressure specified by the manufacturer of the membrane—that reduce the water content of said First Solution in said units and thereby increase the overall lithium concentration thereof so that it is in the range of about 3,000 to 9,000 ppm of dissolved lithium and subsequently,

(b) subjecting said solution processed in (a) to forward osmosis through a plurality of successive and/or parallel semi-permeable forward osmosis membranes in units that further reduce the water content of said solution and thereby further increase the overall lithium concentration thereof so that it is in the range of about 13,000 to about 25,000 ppm of dissolved lithium.

It is to be noted that for the practice of this invention processes are described which utilize forward osmosis process technology to achieve concentration of lithium-containing solutions. Forward osmosis process technology in part relies on use of a forward osmosis membrane designed to allow passage of water through the semi-permeable membrane while rejecting any other ions. This is achieved through a number of mechanisms, one of which is charge rejection. The charge of the ion has a great effect on to what degree passage through the semi-permeable forward osmosis membrane will occur. Large ions with divalent charges, such as calcium and magnesium, have a near 100% rejection against most semi-permeable forward osmosis membranes. However, given the relatively small size of the lithium ion and its low relative density, its charge is more readily attracts surrounding water molecules, resulting in its high enthalpy of hydration. The lithium ion exhibits strong ion-permanent dipole interactions with the surrounding water molecules, giving it a hydrated shell and therein hiding the charge of the lithium ion itself. Hence, it would not be expected that a semi-permeable forward osmosis membrane would exhibit a strong rejection of lithium salts, as its charge is shielded at least to some extent by surrounding water molecules that lend it a hydrated spherical shape, theoretically effectively voiding or minimizing the charge rejection capability of semi-permeable forward osmosis membranes to lithium ions. However, this invention demonstrates the efficacy of and benefits from the use of standard semi-permeable forward osmosis membranes for the concentration of lithium-containing solutions.

Still other embodiments, features, and advantages of this invention will become still further apparent from the ensuing description, appended claims, and accompanying drawings.

### BRIEF DESCRIPTION OF THE DRAWINGS

FIG. 1 is a schematic representation of a forward osmosis process as conducted pursuant to this invention.

FIG. 2 depicts schematically a forward osmosis membrane.

FIG. 3 is a schematic representation of a forward osmosis process conducted on a batch basis in a forward osmosis membrane unit in a manner pursuant to this invention.

FIG. 4 is a schematic representation of a forward osmosis process conducted on a semi-continuous basis in a forward osmosis membrane unit in a manner pursuant to this invention.

FIG. 5 is a schematic representation of a forward osmosis process conducted on a continuous basis in a forward osmosis membrane unit in a manner pursuant to this invention.

FIG. 6 is a schematic representation of a forward osmosis process conducted in a forward osmosis membrane unit in which the active and the draw solutions pass in and out of the unit in countercurrent directions.

FIG. 7 is a schematic representation of a forward osmosis process conducted in a forward osmosis membrane unit in which the active and the draw solutions pass in and out of the unit in concurrent directions.

FIG. 8 is a schematic representation illustrating a forward osmosis process in which a plurality of forward osmosis membrane units are disposed either in series or in parallel or both.

FIG. 9 is a schematic representation of process embodiments of this invention using at least two successive membrane separations, one of which is a reverse osmosis membrane separation and the other of which is a forward osmosis membrane separation wherein the reverse osmosis separation precedes the forward osmosis separation.

### FURTHER DETAILED DESCRIPTION OF THIS INVENTION

In the embodiments of this invention directed to the forward osmosis processes without reference to use of reverse osmosis process, this invention increases the concentration of dissolved lithium salt(s) in a solvated, preferably aqueous, lithium-containing First Solution having (a) an initial osmotic pressure typically in the range of about 300 to about 1,000 psig and (b) an initial concentration of dissolved lithium salts typically in the range of about 1,500 to about 4,500 ppm (wt/wt) of dissolved lithium (Li+), which process comprises feeding a continuous or discontinuous flow of such First Solution into direct contact with one side of at least one semi-permeable forward osmosis membrane. This results in a flow of the First Solution passing over and continuously or discontinuously against one side of said at least one semi-permeable forward osmosis membrane; and maintaining a Second Brine Solution in direct contact with the other side of said membrane, said Second Brine Solution having (c) a content of dissolved salt(s) and (d) during the process, having an osmotic pressure that is higher than the osmotic pressure of the flow of the First Solution that is contacting said at least one semi-permeable forward osmosis membrane; said process being further characterized in that it is does not require the use of (i) superatmospheric pressure, (ii) subatmospheric pressure, (iii) both of superatmospheric pressure and/or subatmospheric pressure sequentially or consecutively, or (iv) one or more additives to assist in causing the flow of water through said membrane from said First Solution and into said Second Brine Solution.

Development of forward osmosis related membranes, membrane elements, and units (also known as housings) for such membranes or elements and commercial applications for such technology such as wastewater reclamation and desalination are known. To date, no patent or scientific literature has been found that references development of a successful process comprising forward osmosis for the concentration of dilute lithium-containing solutions, especially those derived from subterranean brines containing lithium salts. Instead, U.S. Pat. Appln. Nos. 2011/0203994, 2012/0267307, and 2012/0273417 merely mention removing lithium in order to produce potable water either in processes which require use of special solute additives for assisting in generating the osmotic pressure necessary to conduct the separation or in conducting multi-step operations in which, among other things, draw solutions are separated and such solute additives are recovered for readdition to draw solutions.

### Forward Osmosis Process

This invention embodies a process for increasing the concentration of dissolved lithium salt(s) in a First Solution having a content of at least one dissolved lithium salt. Said First Solution is maintained in direct contact with one side of a semi-permeable forward osmosis membrane. A Second Brine Solution is maintained in direct contact with the other side of said membrane, wherein the Second Brine Solution has a content of dissolved salt(s) and an inherent osmotic pressure that is higher than the osmotic pressure of the First Solution during the process. The concentration of dissolved lithium salt(s) in the First Solution is increased by the flux of water from the First Solution through the membrane and into the Second Brine Solution so that the overall concentration of lithium in the First Solution is increased.

This process is conducted without requiring use of (i) superatmospheric pressure or (ii) subatmospheric pressure or (iii) use of both of superatmospheric pressure and/or subatmospheric pressure sequentially or consecutively to assist in causing the flow of water through the membrane from the First Solution and into the Second Brine Solution. Further, the process is characterized in that it is conducted without (i) requiring adjustment of the temperature of the First Solution or (ii) requiring adjustment of the temperature of the Second Brine Solution or (iii) maintaining a temperature differential between the First Solution and brine second solution. A preferred feature of this invention is the ability to operate the process at ambient temperatures as well as elevated temperatures up to 80° C.

### First Solution

In the practice of this invention, the First Solution is an aqueous solution containing some quantity of dissolved lithium salt(s) wherein a higher concentration of said lithium salt(s) is desired. In one case, the First Solution may be an aqueous solution in which the lithium salt is lithium chloride. The First Solution may also and will likely contain other inorganic salts, which, in a non-limiting aspect comprises quantities of sodium chloride, potassium chloride, calcium chloride, and magnesium chloride. Other inorganic salts or minor organic compounds may be included in the First Solution in other cases, depending on the purity, source, or composition of the First Solution. In one case the First Solution contains in the range of about 1,500 to 4,500 ppm of dissolved lithium (Li+) as either part of, or derived from, a brine solution originating from below the Earth's surface. In another case, said first aqueous solution may contain in the range of about 1,500 to 4,500 ppm of dissolved lithium as either part of, or derived from, a subterranean brine solution from which bromine has been removed, or iodine has been removed, or both have been removed. Said First Solutions in general have an osmotic pressure in the broad range of 300 to 1,000 psig prior to concentration.

Examples of typical compositions of the First Solution are shown in Table 1 in terms of their weight percentage of salt concentrations. As evidenced in the two examples shown, the First Solution need not exclusively contain a lithium salt, but rather can contain and will likely contain other monovalent and divalent salts as well. This is especially the case in the First Solutions used as part of a larger process to recover lithium values from subterranean brine.

TABLE 1

| | First Solution | First Solution |
|---|---|---|
| Salt | Example 1 (wt. %) | Example 2 (wt. %) |
| LiCl | 1.40 | 3.00 |
| NaCl | 0.80 | 1.71 |
| KCl | 0.01 | 0.02 |
| CaCl₂ | 0.07 | 0.15 |
| MgCl₂ | 0.11 | 0.24 |

### Second Brine Solution

The Second Brine Solution has a content of dissolved salt(s) giving an inherent osmotic pressure that is higher during the process than the osmotic pressure of said First Solution. The preferred Second Brine Solution is a nearly saturated or a saturated aqueous brine stream. In one case the brine stream may contain inorganic salts which may comprise, on a non-limiting basis, lithium chloride, sodium chloride, potassium chloride, magnesium chloride, and calcium chloride. In some cases, dissolved boron species such as boric acid may also be present. In another case, the Second Brine Solution is an aqueous brine stream from below the Earth's surface. Said subterranean aqueous brine stream may be one in which bromine has been removed, or iodine has been removed, or both. An example of a subterranean aqueous brine stream is shown below. Its high salt concentration lends it to having a high inherent osmotic pressure of greater than 3,000 psig. Table 2 describes typical weight percentages of typical components of the Second Brine Solution. The salts listed give an overview of the major components of the example Second Brine Solution; however a number of other minor inorganic salts are also contained therein, as is the case with most subterranean brine solutions. The high salt concentration of the example Second Brine Solution lends it to having a high inherent osmotic pressure.

TABLE 2

| | Second Brine Solution |
|---|---|
| Salt | Example 1 (wt. %) |
| LiCl | 0-0.2 |
| NaCl | 10-15 |
| KCl | 0-3 |
| CaCl2 | 5-10 |
| MgCl2 | 0-3 |

### Osmotic Pressure

For reference, osmotic pressure can be defined as the minimum pressure needed to prevent the inward flow of water across a semi-permeable membrane to a given solution. For example, if a semi-permeable membrane sac or pouch containing a solution with a solute that cannot pass through the semi-permeable membrane is immersed in pure water, the pure water outside of the sac or pouch will diffuse into the sac or pouch, increasing the pressure inside. The elevated pressure at which diffusion into the sac or pouch ceases and equilibrium is reached is defined as the osmotic pressure of the solution.

Several equations have been developed to approximate the osmotic pressure of solutions. Van't Hoff first proposed a formula for calculation of osmotic pressure, whereby it was later improved by Morse. The Morse equation reads π=iMRT, wherein n is the osmotic pressure of the solution, i is the dimensionless van't Hoff factor which takes into account the dissociation/association of a given solute, M is the molarity of the solution, R is the gas constant, and T is the temperature of the solution. The osmotic pressures given in this invention were calculated using the Morse equation at 25° C.

In this invention, the initial osmotic pressure of the First Solution is in the range of about 300 to about 1,000 psig and preferably in the range of about of about 325 to about 800 psig, whereas the inherent osmotic pressure of said Second Brine Solution is in the broad range of about 1,500 to about 4,000 psig or higher and preferably in the range of about 2,500 to about 3,500 psig and more preferably in the range of about 3,000 to about 3,500 psig.

### Driving Force

The driving force for the flow of water across the forward osmosis membrane is the difference in osmotic pressure between the First Solution and the Second Brine Solution. Owing to the inherent elevated osmotic pressure of the Second Brine Solution relative to the First Solution, there exists a difference in osmotic pressure sufficient to provide for the flux of water across the semi-permeable forward osmosis membrane from the First Solution into the Second Brine Solution, whereby in effect, the loss of water from the First Solution provides a mechanism for the concentration of the lithium salts contained in the First Solution.

The driving force can be described by the equation J=A(ΔP−Δπ) wherein J is the water flux through the semi-permeable forward osmosis membrane, A is the hydraulic permeability of the membrane, ΔP is the transmembrane applied pressure difference, and Δπ is the transmembrane osmotic pressure difference.

Because in this invention the forward osmosis is conducted without requiring use of (i) superatmospheric pressure or (ii) subatmospheric pressure or (iii) both of them to assist in causing the flow of water through the membrane from the First Solution and into the Second Brine Solution, the sole driving force used to provide for the increase in Li ion concentration of the First Solution containing lithium salts is the difference in osmotic pressure between First Solution and the Second Brine Solution. Such difference in osmotic pressure is sufficient to drive water from First Solution to Second Brine Solution, at an economically viable and efficient rate, concentrating said First Solution while at the same time diluting said Second Brine Solution. Equilibrium is reached when the osmotic pressures of the first and second solutions are equivalent. Equilibrium can be avoided—to allow for a constant water flux across the membrane—by making the Second Brine Solution a continuous flow. Given that there exists subterranean brine solutions available on a continuous basis, the continuous operation is not only plausible, but highly desirable. Further, because the osmotic pressure of the second brine is inherent, meaning that it is preexisting, or existing as used, there is no need for makeup or synthesis of a synthetic Second Brine Solution containing external additives to provide the elevated osmotic pressure.

### Forward Osmosis Membranes

It is contemplated and indeed expected that any of a wide variety of currently available commercial forward osmosis membranes may be utilized in the practice of this invention. Further as future improvements in forward osmosis membrane technology take place, membranes not now contemplated may become available for use in the practice of this invention. Currently, two preferred types of commercially available forward osmosis membranes arc thin film composite membranes and cellulose acetate membranes. Thin film composite membranes are generally composed of multiple layers of materials. Typically the active layer of thin film composite forward osmosis membranes is a thin polyamide layer attached to a polysulfone or polyethersulfone porous backing layer. Said two layers sit on top of a non-woven fabric support (commonly composed of polyester) that provides rigidity to the forward osmosis membrane. Cellulose acetate forward osmosis membranes are asymmetric membranes composed solely of cellulose acetate (in diacetate and triacetate forms or blends thereof). Cellulose acetate membranes have a dense surface skin (active layer) supported on a thick non-dense layer. While the layers are made of the same polymer, they are normally dissimilar in structural composition.

The active layer of semi-permeable forward osmosis membranes is responsible for the rejection of ions and other large molecules present in said First Solution while the additional layer(s) serve to provide mechanical strength. In one example application, the active layer contacts the First Solution while the support layer(s) contacts the Second Brine Solution. In another example application, the active layer contacts the Second Brine Solution, while the support layer(s) contact the first solution. Based on laboratory testing, in the first example application, a higher flux of water across the membrane can be achieved when compared to the second example application. However, in another consideration, it was found that the fouling potential of the semi-permeable forward osmosis membrane was lower in the second example application as a result of the membrane orientation. Membrane fouling is an important consideration in operation of any membrane-based process, wherein fouling is defined as the deposition of solute—in one example, inorganic salts—onto the membrane surface or into the membrane pores in a way that decreases membrane performance, commonly manifested as a decrease in water flux across the membrane or a decrease in the rejection ability of the membrane. While both example applications of membrane orientation work effectively, the differences in flux and fouling potential are important considerations. Laboratory demonstrations of the two applications showed rejection of ions is comparable in both cases.

The thickness of forward osmosis membranes is largely a result of the thickness of the support layer. Thin membranes allow for higher water fluxes and reduce the potential of fouling—by a reduction in area and mass. While thinner membranes are desirable, sufficient structural integrity is also needed to withstand a given operating environment. The dense active layer of cellulose acetate forward osmosis membranes is typically 0.1-0.2 μm thick while the support layer is on the order of 100-200 μm in thickness. The polyamide active layer of thin film membranes is typically 0.2-0.25 μm thick, while the polysulfone backing support layer is typically 40-50 μm thick. The polyester nonwoven support layer is usually on the order of 100 μm in thickness. The dimensions given are intended to be non-limiting, and the forward osmosis membranes used in this invention may comprise alternate constructions and/or dimensions. Extensive laboratory testing was done on a variety of commercially available forward osmosis membrane and in general, the membranes showed admirable structural integrity and showed no visible signs of degradation after repeated operation at both ambient temperature as well as at 70° C.

### Modes of Operation

In conducting forward osmosis pursuant to this invention the operation can be conducted on a batch basis in a unit (also known as housing) which supports a forward osmosis membrane and also divides the unit into a first and second internal chamber. The first chamber is adapted to receive a flow of said First Solution and contact it with one side of said forward osmosis membrane and recirculate said flow back into said first chamber. The second chamber is designed to receive a flow of said Second Brine Solution and contact it with the other side of said forward osmosis membrane and recirculate said flow back into said second chamber. During operation of the process, water is caused to flux through said semi-permeable forward osmosis membrane as a result of the difference in osmotic pressure between said solution in said first and second chambers, wherein the water flows from said first chamber to said second chamber. In effect, the lithium concentration of said First Solution is increased. Because both said First Solution and said Second Brine Solution are recirculated, in effect, said First Solution is continually concentrated (with respect to lithium) while said Second Brine Solution is continually diluted (with respect to the increase in water content). This concentration/dilution will continue to take place until said First Solution has an equivalent osmotic pressure to said Second Brine Solution, thus signifying equilibrium and the loss of a driving force to cause the flux of water from said First Solution to said Second Brine Solution. In the experiments conducted at the laboratory scale a finite volume of both the first and Second Brine Solutions were recirculated individually. This resulted in the successful concentration of the finite volume of feed solution and the dilution of the finite volume of the draw solution as described.

The concentration process using forward osmosis technology may also be conducted on a semi-continuous basis in a unit (also known as housing) which supports a forward osmosis membrane and divides the unit into a first and second internal chamber. The first chamber is adapted to receive a flow of said First Solution and contact it with one side of said membrane and recirculate said flow back into said first chamber. The second chamber is adapted to receive a continuous or pulsed flow of non-recycled Second Brine Solution into, through, and out of said second chamber while causing said Second Brine Solution to contact the other side of said membrane. During operation of the process, water is caused to flux through said semi-permeable forward osmosis membrane as a result of the difference in osmotic pressure between said solution in said first and second chambers, wherein the water flows from said first chamber to said second chamber. In effect, the lithium concentration of said First Solution is increased. Because the operation is conducted on a semi-continuous basis, with the First Solution being recycled and the Second Brine Solution being run continuously through the forward osmosis unit, equilibrium between the First Solution and Second Brine Solution is not reached until the First Solution has lost enough water and increased in salt concentration to the point that it has an equivalent osmotic pressure of said starting Second Brine Solution. Thus, the semi-continuous process provides for a greater level of concentration at a faster rate compared to the previous embodiment conducted on a batch basis in this case through recirculation of the First Solution and non-recycle of the Second Brine Solution.

In still yet another embodiment, the lithium concentration process using forward osmosis technology is conducted on a continuous basis in a unit (also known as housing) which supports a forward osmosis membrane and divides the unit into a first and second internal chamber. The first chamber is adapted to receive a continuous or pulsed flow of the First Solution that is not non-recycled into, through, and out of said first chamber while causing said First Solution to contact one side of said membrane. The second chamber is adapted to receive a continuous or pulsed flow of non-recycled Second Brine Solution into, through, and out of said second chamber while causing said Second Brine Solution to contact the other side of said membrane. During operation of the process, water is caused to flux through said semi-permeable forward osmosis membrane as a result of the difference in osmotic pressure between said solutions in said first and second chambers, wherein the water flows from said first chamber to said second chamber. In effect, the lithium concentration of said First Solution is increased. Because neither the First Solution nor the Second Brine Solution is recirculated or recycled, the process is completely continuous and will not reach steady-state or a point of equilibrium during a period of operation of said process. Said embodiment allows for the continual concentration of the lithium in the First Solution given the continual availability of the First Solution and Second Brine Solution. Said Second Brine Solution can especially be considered continually available in cases in which said Second Brine Solution originates from below the Earth's surface and is available as part of other processes.

In these modes of operation (batch, semi-continuous, and continuous), the forward osmosis units may be adapted to permit flow of the First Solution and Second Brine Solution in and out of the unit in countercurrent or concurrent flow directions. Countercurrent or concurrent directional flow of the First Solution and/or Second Brine Solution may occur as (i) recirculated flow, (ii) continuous flow. (iii) pulsed flow, or (iv) a combination of any two of these flows. Countercurrent flow of the First Solution and Second Brine Solution on opposite sides of the semi-permeable forward osmosis membrane maximizes the osmotic pressure difference observed at any given point on either side of the membrane.

### Plurality of Units

On an industrial scale, use of a continuous one-pass operation is generally preferred. In such operation the forward osmosis membrane units may be staged either in series or parallel or both, so that at the end of the last forward osmosis unit the desired concentration is reached. Feeding the Second Brine Solution continuously will aid in maintaining a large driving force for water flux across the membrane, as the Second Brine Solution osmotic pressure will not be decreased as a result of continual dilution and reuse.

### Sequential Reverse Osmosis to Forward Osmosis Process

Though partially similar in name, forward osmosis process technology differs significantly from reverse osmosis process technology. Reverse osmosis process technology relies on the application of pressure—typically to an aqueous First Solution—to drive water from the First Solution through a semi-permeable reverse osmosis membrane, producing a more concentrated First Solution and a separate second water stream. The pressure applied must be greater than the osmotic pressure of the First Solution for water to pass through the semi-permeable membrane. The difference between the applied pressure and osmotic pressure of the First Solution is the driving force in reverse osmosis process technology. In contrast, in the forward osmosis process technology of this invention, the driving force is the difference in osmotic pressure between the First Solution and a Second Brine Solution, in reverse osmosis said Second Brine Solution is not present.

While currently developed reverse osmosis does require application of substantial pressure to achieve concentration, it is useful in that it produces a nearly pure water stream as a result of the water that permeates through the semi-permeable reverse osmosis membrane. This water stream can then be recycled elsewhere in a process. Such a recyclable water stream is desirable in processes in which water availability is limited or wherein water balances must operate within small limits. Given that reverse osmosis is capable of concentrating a First Solution and that it produces a recycle second water stream, such process technology in some cases, may be used in tandem with the previously presented forward osmosis technology process.

In one case, the First Solution may contain in the range of about 1,500 to 4,500 ppm of lithium, wherein said First Solution is subjected to pressurized reverse osmosis through a likely plurality of semi-permeable reverse osmosis membranes in units staged in series or parallel or both, with pressure applied to said First Solution. In said reverse osmosis process, water is forced across the semi-permeable reverse osmosis membrane while the ions contained within the First Solution are rejected and remain on the First Solution side of the reverse osmosis membrane. Said reverse osmosis process technology does not require use of a Second Brine Solution on the opposite side of the semi-permeable reverse osmosis membrane. The flux of water across the membrane provides for the concentration of the First Solution. While the reverse osmosis process requires substantial applied pressure, its benefit is the isolatable water stream it provides through the flux of water across the semi-permeable reverse osmosis membrane. This allows for an amount of water recovery during the invented concentration process. In one case, this concentration takes the First Solution lithium concentration from a range of about 1,500 to 4,500 ppm of dissolved lithium to a range of about 3,000 to 9,000 ppm of dissolved lithium. In this embodiment of the process of the invention, the First Solution of increased dissolved lithium solution is subsequently subjected to forward osmosis through a plurality of semi-permeable forward osmosis membranes in units staged in series or parallel or both. The First Solution may contact either the active or support/backing side of the forward osmosis membrane as (i) recirculated, (ii) continuous, (iii) pulsed flow, or (iv) as any combination of two of these flows relative to the Second Brine Solution which contacts the opposite side of the forward osmosis membrane. The Second Brine Solution may contact the forward osmosis as (i) recirculated, (ii) continuous, (iii) pulsed flow, or (iv) as any combination of two of these said flows. In one case of this embodiment, in the forward osmosis process, wherein water is caused to flux from the First Solution to the Second Brine Solution, the concentration of the First Solution exiting said reverse osmosis process containing in the range of about 3,000 to 9,000 ppm of dissolved lithium extends to about 13,000 to 25,000 ppm of dissolved lithium.

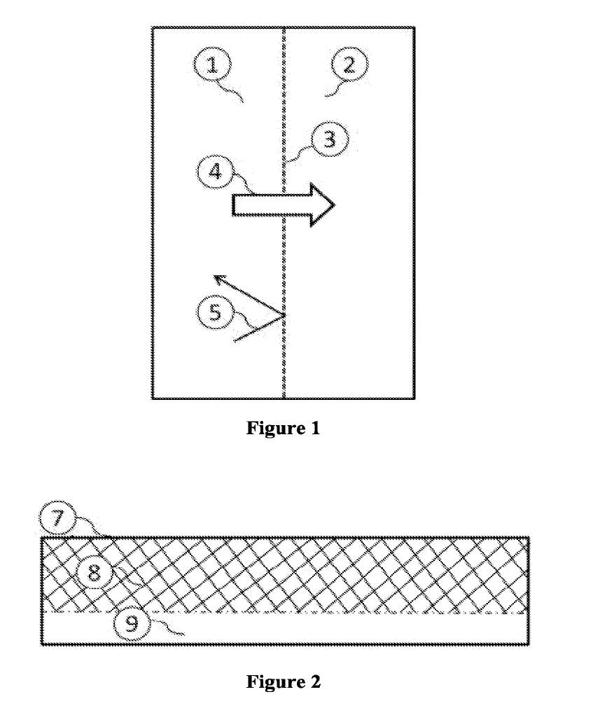

Turning now to the drawings, FIG. 1 represents schematically process embodiments of this invention wherein in a unit 6 a First Solution 1 is maintained in direct contact with once side of a semi permeable forward osmosis membrane 3 while maintaining in direct contact with the other side of said membrane a Second Brine Solution 2, the concentration of dissolved lithium salts 5 in the First Solution 1 is increased by the flux of water 4 from the First Solution 1 through said membrane 3 and into said Second Brine Solution 2.

FIG. 2 represents a forward osmosis membrane 7 that has an active membrane side 9 and a backing/support side 8.

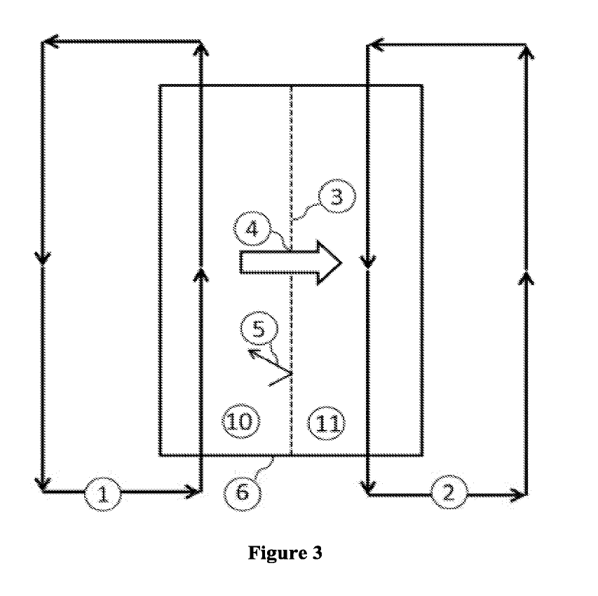

FIG. 3 represents a process embodiment of FIG. 1 wherein the process is conducted on a batch basis in a unit 6 which supports a forward osmosis membrane 3 and divides the unit into a first 10 and second 11 internal chamber in which said first chamber 10 is adapted to receive a flow of said First Solution 1 and contact it with one side of said membrane 3 and recirculate this flow 1 back into said first chamber 10, and wherein said second chamber 11 is adapted to receive a flow of the Second Brine Solution 2 and contacts it with the other side of said membrane 3 and recirculates the flow 2 back into said second chamber 11 whereby water is caused to flux 4 through said membrane 3 from said first chamber 10 and into said second chamber 11, thereby increasing the lithium 5 concentration of said recirculated First Solution 1.

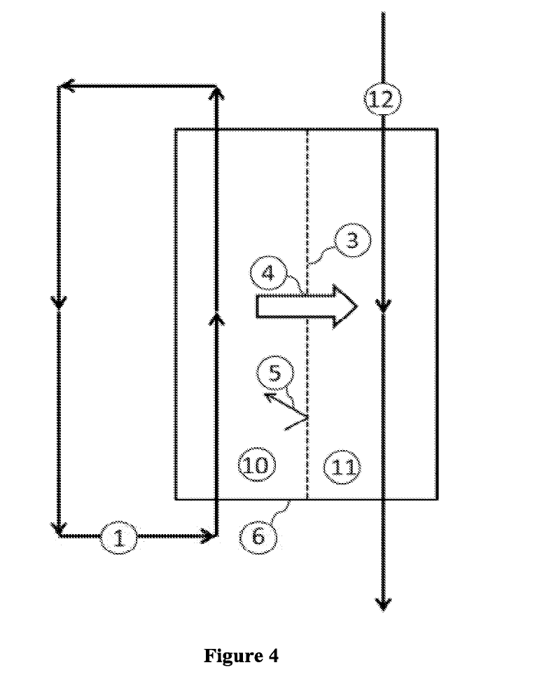

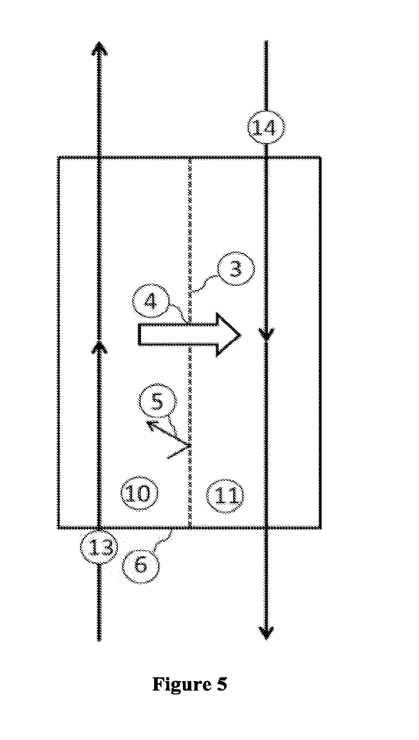

FIG. 4 represents a process embodiment of FIG. 1 wherein the process is conducted on a semi-continuous basis in a unit 6 which supports a forward osmosis membrane 3 and divides the unit into a first 10 and second 11 internal chamber in which the first chamber 10 is adapted to receive a flow of the First Solution 1 and contact it with one side of said membrane 3 and recirculate said flow 1 back into said first chamber 10, and wherein said second chamber 11 is adapted to receive a continuous or pulsed flow of non-recycled Second Brine Solution 12 into, through, and out of the second chamber while causing the Second Brine Solution 12 to contact the other side of said membrane 3, whereby water is caused to flux through said membrane as depicted by arrow 4 from said first chamber 10 into this second chamber 11, thereby increasing the lithium 5 concentration of said recirculated First Solution 1.

FIG. 5 represents a process embodiment of FIG. 1 wherein the process is conducted on a continuous basis in a unit 6 which supports a forward osmosis membrane 3 and divides the unit into a first 10 and second 11 internal chamber in which said first chamber 10 is adapted to receive a continuous or pulsed flow of non-recycled First Solution 13 into, through, and out of the first chamber 10 while causing said First Solution 13 to contact one side of said membrane as indicated by 3, and wherein the second chamber 11 is adapted to receive a continuous or pulsed flow of non-recycled Second Brine Solution 14 into, through, and out of said second chamber 11 while causing the Second Brine Solution 14 to contact the other side of said membrane as indicated by 5, whereby water is caused to flux as indicated by arrow 4 through said membrane 3 from the first chamber 10 into the second chamber 11, thereby increasing the lithium 5 concentration of the non-recycled First Solution 13.

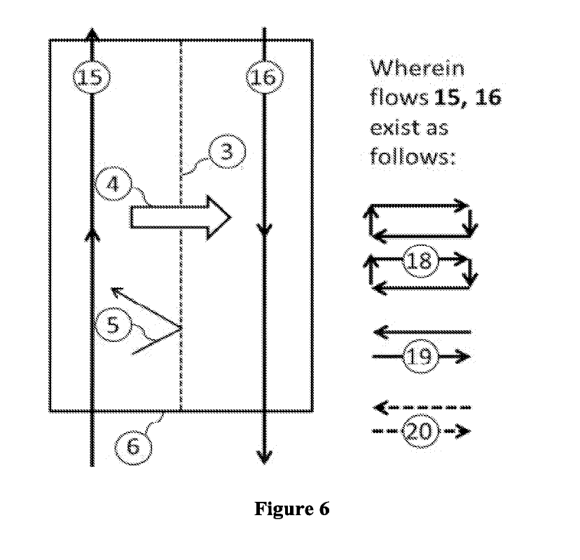

FIG. 6 represents process embodiment of FIG. 1 wherein unit 6 is adapted to permit both of flows 15, 16 to pass in and out of said unit in countercurrent directions whereby flow of said first 15 and second solutions 16 can occur at any time through said unit 6 during the operation of the process (i) as recirculated countercurrent flow 18, or (ii) as continuous countercurrent flow 19, or (iii) as pulsed countercurrent flow 20, or (iv) as any combination of any two of said flows of (i) 18, (ii) 19, or (iii) 20.

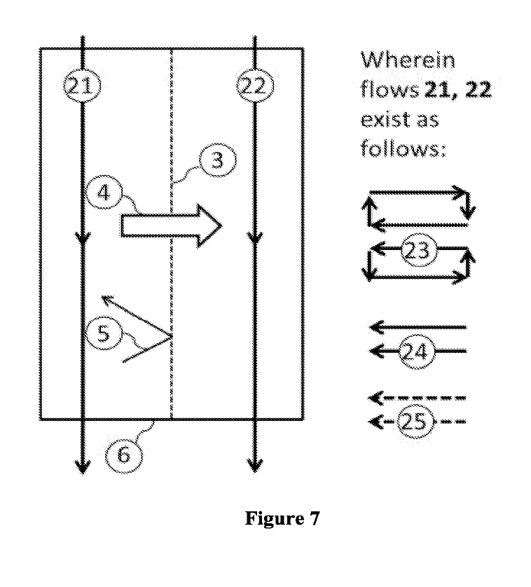

FIG. 7 represents a process embodiment wherein said unit 6 is adapted to permit both flows 21, 22 to pass in and out of the unit in concurrent directions whereby flow of said first 21 and second 22 solutions can occur at any time through said unit during the operation of the process 0 (i) as recirculated concurrent flow 23, or (ii) as continuous concurrent flow 24, or (iii) as pulsed concurrent flow 25, or (iv) as any combination of any two of said flows of (i) 23, (ii) 24, or (iii) 25.

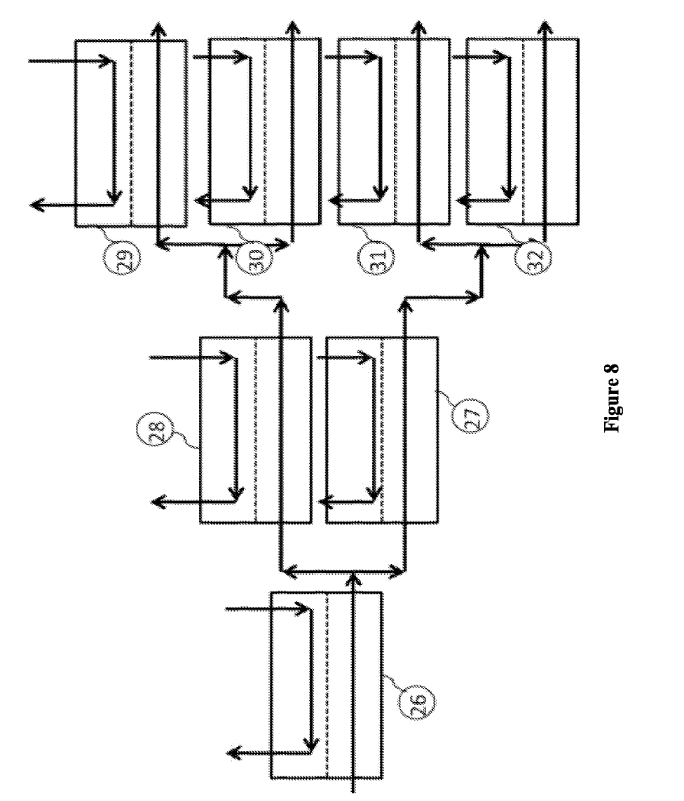

FIG. 8 represents a process wherein unit 27 is one of a plurality of units 26-32 which are disposed either in series as in 27 to 26, 31, 32 or in parallel as in 27 to 28 or both 27 to 26, 28-32.

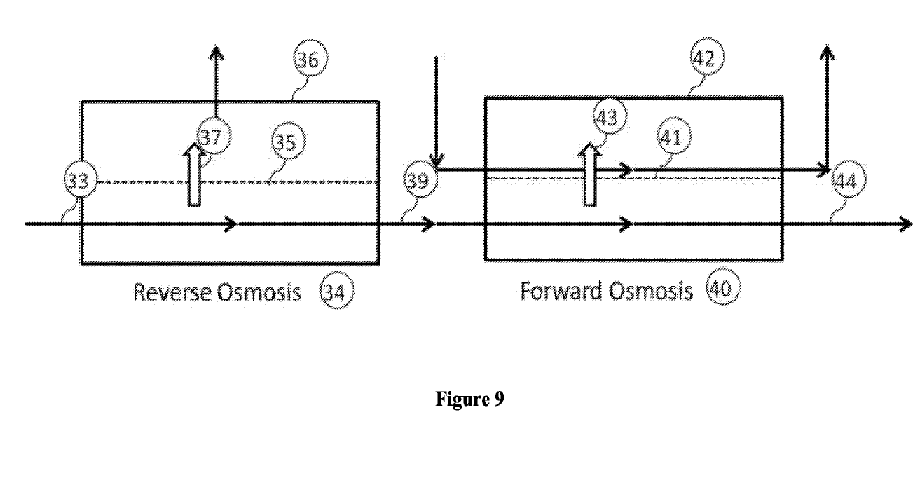

FIG. 9 represents schematically process embodiments of this invention for concentrating an aqueous First Solution 33 containing in the range of about 1,500 to 4,500 ppm of dissolved lithium, which process comprises: (a) subjecting said solution to pressurized reverse osmosis expressed as 34 through a plurality of successive or parallel semi-permeable reverse osmosis membranes (collectively represented by numeral 35) in a plurality of units (collectively represented by numeral 36) that reduce the overall water content as indicated by arrow 37 of said First Solution 33 and thereby increase the lithium concentration thereof so that it is in the range of about 3,000 to 9,000 ppm of dissolved lithium as it is transferred as at 39 to forward osmosis (expressed as 40) and subsequently, subjecting said solution 39 to forward osmosis 40 through a plurality of successive or parallel semi-permeable forward osmosis membranes (collectively represented by numeral 41) in units (collectively represented by numeral 42) that further reduce the water content 43 of said solution 39 and thereby further increasing the lithium concentration thereof so that it is in the range of about 13,000 to about 25,000 ppm of dissolved lithium collection as at 44.

To demonstrate typical operations of the present invention, the following experimental information based on laboratory scale operations is presented. In particular, this work demonstrates operations in which forward osmosis process technology and/or reverse osmosis process technology is effectively utilized pursuant to this invention.

To demonstrate typical operations of the present invention, the following experimental information based on laboratory scale operations is presented. In particular, this work demonstrates operations in which forward osmosis process technology and/or reverse osmosis process technology is effectively utilized pursuant to this invention.

### Example I

Forward Osmosis Process Technology of this Invention

In the first set of these operations, three non-limiting key variables deemed to be vital to successful operation of the forward osmosis process technology of this invention were evaluated. Thus, the variables demonstrating the practicality of the process technology invention were (i) water flux across the membrane from the First Solution to the Second Brine Solution, (ii) lithium ion transport across the semi-permeable forward osmosis membrane, and (iii) membrane stability at elevated temperatures.

### Materials Used

In general, the First Solution used in laboratory testing was a representative process stream containing between 1.0 and 3.0 wt % lithium chloride as the lithium-containing salt. Such process stream is part of an overall process to extract lithium values from subterranean brine. The First Solution used in this experimental work additionally contained a plurality of salts comprising 0.80 wt % sodium chloride, 0.01 wt % potassium chloride, 0.07 wt % calcium chloride, and 0.10 wt % magnesium chloride in addition to other, less prevalent inorganic salts typically found in subterranean solutions. The second solution used was also a representative subterranean stream comprised of 0-0.2 wt % lithium chloride, 10-15 wt % sodium chloride, 0-3 wt % potassium chloride, 5-10 wt % calcium chloride, and 0-3 wt % magnesium chloride. The forward osmosis unit used to house the semi-permeable forward osmosis membrane was a commercially-available Sterlitech CF042 crossflow cell containing a singular flat sheet forward osmosis membrane supported between two crossflow chambers. The cell is generally considered to be a standard testing apparatus for forward osmosis process technology evaluation as well as for general flat sheet membrane testing on a laboratory scale. A variety of commercially available forward osmosis membranes were tested in the cell, comprising both thin film composite membranes and cellulose acetate membranes.

### Procedure

In laboratory demonstrations, one liter of the First Solution was recirculated through one crossflow chamber of the CF042 cell at a flow rate of 1 liter per minute. A peristaltic pump was used to flow said First Solution into, through, and out of one chamber of the CF042 cell, while allowing said First Solution to contact one of the sides of the enclosed semi-permeable forward osmosis membrane. At the same time, four liters of Second Brine Solution were recirculated through the second chamber of the CF042 cell using a peristaltic pump at a flow rate of 1 liter per minute. The second solution flowed into, through, and out of said second chamber, contacting the opposite side of said semi-permeable forward osmosis membrane. The First Solution and Second Brine Solution were both maintained at atmospheric pressure. Experiments were conducted with the First Solution and Second Brine Solution maintained at ambient temperature (near 25° C.). Additional experiments were conducted with both solutions maintained at an elevated temperature of 70° C.

During each experiment, the mass of the First Solution was monitored and recorded, so that the rate of water transfer and overall flux of water from said First Solution to the Second Brine Solution could be determined. In addition, samples of said First Solution and said Second Brine Solution were taken at varying time intervals and analyzed using inductively coupled plasma (ICP) analytical equipment. As noted above, the membranes were disposed so that one of the sides of the membranes was exposed separately to the First Solution and Second Brine Solution and vice versa.

### Results

Laboratory experimental results show that at both 25° C. and 70° C., concentration of the First Solution readily occurs. Water flux across the membrane ranged from 14 liters per meter squared per hour at ambient temperature to upwards of 40 liters per meter squared per hour at the elevated temperature. In general, rejection of lithium chloride transport across the semi-permeable forward osmosis membrane was at or greater than 90 percent, meaning that only 10% or less of the lithium chloride in the First Solution permeated through the forward osmosis membrane to the Second Brine Solution. A high rejection of lithium salts in the First Solution is important, in order to ensure efficient concentration of lithium in said First Solution while preventing losses to said second solution. Experimentally concentrations near 12 wt/o lithium chloride were achieved in the First Solution before a near equilibrium state was reached between the First Solution and Second Brine Solution with respect to osmotic pressure. An example of the concentrated First Solution composition is given in Table 3 below.

TABLE 3

| | Concentrated First Solution |
|---|---|
| Salts | Example 1 (wt. %) |
| LiCl | 12 |
| NaCl | 7.5 |
| KCl | 0.1 |
| CaCl₂ | 0.7 |
| MgCl₂ | 1.7 |

### Example II

Reverse Osmosis Process Technology of this Invention

As noted above, one aspect of this invention involves use of reverse osmosis followed sequentially by forward osmosis. Accordingly, the following experimental work was conducted to establish the conditions appropriate for conducting reverse osmosis as a part of the overall two-stage operation of reverse osmosis followed by forward osmosis. The laboratory-scale experiments conducted to demonstrate the reverse osmosis process technology for the concentration of lithium containing solutions involved two non-limiting key variables. The key variables considered when evaluating the practicality of the process technology invention were (i) water flux across the membrane from the First Solution and (ii) lithium ion transport across the semi-permeable reverse osmosis membrane. Demonstration experiments were carried out in similar manner to the above described forward osmosis process technology experiments.

In these experiments, one to four liters of a First Solution had a composition of 1.4 wt % lithium chloride, 0.80 wt % sodium chloride, 0.07 wt % calcium chloride, and 0.10 wt % magnesium chloride. This solution was recirculated at a flow rate of 1-2 liters per minute through the Sterlitech CF042 crossflow cell adapted for reverse osmosis laboratory testing. The First Solution was passed into through and out of one chamber of the CF042 cell, allowing the First Solution to contact an enclosed semi-permeable reverse osmosis membrane. A variety of commercially-available semi-permeable reverse osmosis membranes commonly used for seawater desalination was evaluated. The pressure of the First Solution was maintained at 1000 psig or less and the temperature was maintained between 20° C. and 30° C.

During each experiment, the mass of the second water stream produced from the transport of water from the First Solution across the membrane was recorded, so that in effect, the rate and flux of water transport across the semi-permeable forward osmosis membrane could be determined. In addition, samples of said First Solution and the second water solution were taken at varying time intervals and analyzed using inductively coupled plasma (ICP) analytical equipment.

### Results

Laboratory experiment results show that at the conditions specified, concentration of the First Solution readily took place while producing a recyclable second water stream. Water flux across the membrane ranged from 20 to 30 liters per meter squared per hour depending on the semi-permeable reverse osmosis membrane used. In general, rejection of lithium chloride transport across the semi-permeable reverse osmosis membrane was at or greater than 85%, in some cases exhibiting rejections greater than 90%, meaning that only 10-15% of the lithium chloride in the First Solution permeated through the reverse osmosis membrane to the recyclable second water stream. Recovery of the lithium chloride from the recyclable second water stream can be achieved, if desired, by (a) recycling said recycle stream to the process, or (b) subjecting the recycle stream to an additional reverse osmosis. A high rejection of lithium salts in the First Solution is important, in order to ensure efficient concentration of lithium in the First Solution. In these experiments, lithium chloride concentrations of about 3 wt % were achieved in the First Solution. An example of the composition of the concentrated First Solution obtained in this work is given in Table 4.

TABLE 4

| | Concentrated First Solution |
|---|---|
| Salts | Example 2 (wt. %) |
| LiCl | 3.00 |
| NaCl | 1.71 |
| KCl | 0.02 |
| CaCl₂ | 0.15 |
| MgCl₂ | 0.25 |

From the experimental work reported above, it was concluded that the process features of this invention are readily demonstrable on a laboratory scale and are deemed suitable for commercial operations.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition.

Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text taken in context clearly indicates otherwise.

Each and every patent or other publication or published document referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

1. A process for increasing the concentration of dissolved lithium salt(s) in a First Solution having a content of at least one dissolved lithium salt(s), which process comprises:
(a) maintaining said First Solution in direct contact with one side of a semi-permeable forward osmosis membrane and
(b) maintaining in direct contact with the other side of said membrane, a Second Brine Solution a minimum content of dissolved salt(s) in the range of from about 15 wt % below the saturation point up to the saturation point of the Second Brine Solution, and having an inherent osmotic pressure that is higher than the osmotic pressure of said First Solution during the process,
(c) whereby the concentration of dissolved lithium salt(s) in said First Solution is increased by the flux of water from said First Solution through said membrane and into said Second Brine Solution so that the overall concentration of lithium in said First Solution is increased,
(d) independently maintain the temperature(s) of said First Solution and said Second Brine Solution in the range of about 5° C. to about 95° C.,
(e) said process being further characterized in that it is conducted without requiring use of (i) superatmospheric pressure or (ii) subatmospheric pressure or (iii) both of superatmospheric pressure and/or subatmospheric pressure sequentially or consecutively or (iv) one or more additives to assist in causing the flow of water through said membrane from said First Solution and into said Second Brine Solution.

2. A process as in claim 1 wherein the dissolved lithium salt(s) in said First Solution comprise(s) dissolved lithium chloride.

3. A process as in claim 1 wherein said First Solution comprises at least dissolved lithium chloride, sodium chloride, and calcium chloride.

4. A process of claim 1 wherein said forward osmosis membrane has an active membrane side and a backing/support side.

5. A process as in claim 1 wherein the process is conducted on a batch basis in a unit which supports a forward osmosis membrane and also divides the unit into a first and second internal chamber in which said first chamber is adapted to receive a flow of said First Solution and contact it with one side of said membrane and recirculate said flow back into said first chamber, and wherein said second chamber is adapted to receive a flow of said Second Brine Solution and contact it with the other side of said membrane and recirculate said flow back into said second chamber during a period of operation of the process, whereby water is caused to flux through said membrane from said first chamber and into said second chamber, thereby increasing the lithium concentration of said recirculated First Solution.

6. A process as in claim 1 wherein the process is conducted on a semi-continuous basis in a unit which supports a forward osmosis membrane and divides the unit into a first and second internal chamber in which said first chamber is adapted to receive a flow of said First Solution and contact it with one side of said membrane and recirculate said flow back into said first chamber, and wherein said second chamber is adapted to receive a continuous or pulsed flow of non-recycled Second Brine Solution into, through, and out of said second chamber while causing said Second Brine Solution to contact the other side of said membrane during a period of operation of the process, whereby water is caused to flux through said membrane from said first chamber into said second chamber, thereby increasing the lithium concentration of said recirculated First Solution.

7. A process as in claim 1 wherein the process is conducted on a continuous basis in a unit which supports a forward osmosis membrane and divides the unit into a first and second internal chamber in which said first chamber is adapted to receive a continuous or pulsed flow of non-recycled First Solution into, through, and out of said first chamber while causing said First Solution to contact one side of said membrane, and wherein said second chamber is adapted to receive a continuous or pulsed flow of non-recycled Second Brine Solution into, through, and out of said second chamber while causing said Second Brine Solution to contact the other side of said membrane during a period of operation of the process, whereby water is caused to flux through said membrane from said first chamber into said second chamber, thereby increasing the lithium concentration of said non-recycled First Solution.

8. A process as in claim 7 wherein said unit is adapted to permit both of said flows to pass in and out of said unit in countercurrent directions whereby flow of said first and second solutions can occur at any time through said unit during the operation of the process (i) as recirculated countercurrent flow, or (ii) as continuous countercurrent flow, or (iii) as pulsed countercurrent flow, or (iv) as any combination of any two of said flows of (i), (ii), or (iii).

9. A process as in claim 7 wherein said unit is adapted to permit both of said flows to pass in and out of the unit in concurrent directions whereby flow of said first and second solutions can occur at any time through said unit during the operation of the process (i) as recirculated concurrent flow, or (ii) as continuous concurrent flow, or (iii) as pulsed concurrent flow, or (iv) as any combination of any two of said flows of (i), (ii), or (iii).

10. A process as in claim 7 wherein said unit is one of a plurality of units which are disposed either in series or in parallel or both.

11. A process as in claim 7 wherein said unit is adapted to permit both of said flows to pass in and out of said unit in countercurrent directions whereby flow of said first and second solutions can occur at any time through said unit during the operation of the process (i) as recirculated countercurrent flow, or (ii) as continuous countercurrent flow, or (iii) as pulsed countercurrent flow, or (iv) as any combination of any two of said flows of (i), (ii), or (iii), and wherein said unit is one of a plurality of units which are disposed either in series or in parallel or both.

12. A process as in claim 7 wherein said unit is adapted to permit both of said flows to pass in and out of the unit in concurrent directions whereby flow of said first and second solutions can occur at any time through said unit during the operation of the process (i) as recirculated concurrent flow, or (ii) as continuous concurrent flow, or (iii) as pulsed concurrent flow, or (iv) as any combination of any two of said flows of (i), (ii), or (iii), and wherein said unit is one of a plurality of units which are disposed either in series or in parallel or both.

13. A process as in claim 1 wherein said semi-permeable forward osmosis membrane is a (a) thin film composite membrane comprised of an active semi-permeable layer and a backing/support layer of (i) a different film and/or (ii) a porous support member or (b) a cellulose acetate membrane comprised of an active semi-permeable layer and a porous support member, and wherein said osmosis membrane is disposed and supported between said first and second solutions with the active semi-permeable layer facing and in direct contact with said First Solution.

14. A process as in claim 1 wherein said semi-permeable forward osmosis membrane is a (a) thin film composite membrane comprised of an active semi-permeable layer and a backing/support layer of (i) a different film and/or (ii) a porous support member or (b) a cellulose acetate membrane comprised of an active semi-permeable layer and a porous support member, and wherein said osmosis membrane is disposed and supported between said first and second solutions with the active semi-permeable layer facing and in direct contact with said Second Brine Solution.

15. A process for concentrating an aqueous First Solution containing in the range of about 1,500 to 4,500 ppm of dissolved lithium, which process comprises:
(a) subjecting said solution to pressurized reverse osmosis through a plurality of successive or parallel semi-permeable reverse osmosis membranes in units that reduce the water content of said First Solution to produce a recyclable second water stream in said units and thereby increase the overall lithium concentration of said First Solution so that it is in the range of about 3,000 to about 9,000 ppm of dissolved lithium and subsequently,
(b) subjecting said solution processed in (a) to forward osmosis through a plurality of successive or parallel semi-permeable forward osmosis membranes in units that further reduce the water content of said solution and thereby further increase the overall lithium concentration thereof so that it is in the range of about 13,000 to about 25,000 ppm of dissolved lithium.

16. A process as in claim 15 wherein in (b) said aqueous First Solution processed in (a) is (i) brought into direct contact with one side of a plurality of semi-permeable forward osmosis membranes, and (ii) maintaining in direct contact with the other side of said membrane, a Second Brine Solution having a content of dissolved salt(s) and having an inherent osmotic pressure that is higher than the osmotic pressure of said First Solution during the process, whereby the concentration of dissolved lithium salt(s) in said First Solution is increased by the flux of water from said First Solution through said membrane and into said Second Brine Solution so that the overall concentration of lithium in said First Solution is increased to be in the range of about 13,000 to about 25,000 ppm of dissolved lithium, wherein (iii) said process is further characterized in that it is conducted without requiring use of superatmospheric pressure or subatmospheric pressure or use of both of superatmospheric pressure and/or subatmospheric pressure sequentially or consecutively or the use of any additive to assist in causing the flow of water through said membrane from said First Solution and into said Second Brine Solution.

17. A process as in claim 15 wherein said aqueous First Solution containing in the range of about 1500 to 4500 ppm of dissolved lithium is a brine solution additionally containing at least dissolved salts of sodium and/or calcium.

18. A process as in claim 15 wherein said aqueous solution containing in the range of about 1500 to 4500 ppm of dissolved lithium is derived from either (a) a brine solution obtained from below the Earth's surface or (b) a naturally occurring subterranean brine solution from which bromine has been removed or iodine has been removed, or both have been removed.

19. (canceled)

20. A process as in claim 18 wherein said subterranean brine solution is one from which bromine has been removed and which contains at least dissolved salts of lithium, sodium, potassium, calcium, and magnesium, and additionally boric acid.

21. A process as in claim 17 wherein said aqueous solution containing in the range of about 1500 to 4500 ppm of dissolved lithium is either (a) a brine solution obtained from below the Earth's surface, or (b) obtained from a naturally occurring subterranean brine solution from which bromine has been removed or iodine has been removed, or both have been removed.

22. (canceled)
